(19) United States
(12) Patent Application Publication
(10) Pub. No.: US 2002/0197528 A1
(43) Pub. Date: Dec. 26, 2002

(54) Method for extending an application, to be installed using an installation program, by a function, and a computer software product

(75) Inventor: Michael Zunke, Aschheim (DE)

Correspondence Address: Gerald H. Kiel, Esq., REED SMITH LLP, 375 Park Avenue, New York, NY, 10016-2391, US

(73) Assignee: Aladdin Knowledge Systems GmbH & Co. KG

(21) Appl. No.: 09/957,296

(22) Filed: Sep. 19, 2001

(30) Foreign Application Priority Data
Jun. 26, 2001 (EP) 01 115 383.0

(51) Int. Cl. H01M 2/16; H01M 10/12

(52) U.S. Cl. 429/144; 29/623.1

(57) ABSTRACT

A method for extending an application, which is to be installed using an installation program, by a function, wherein the application to be installed comprises a component to be installed by the installation program, the component being stored in a program archive, and wherein the installation program, together with the program archive, forms a software package, comprises carrying out the following steps: adding to the software package a version of the component to be installed, the version being extended by the function, and an auxiliary code without removing the component from the program archive, and modifying the installation program such that its execution leads to the execution of the auxiliary code. The auxiliary code causes the extended component to be installed instead of the component.

### CROSS-REFERENCE TO RELATED APPLICATION

This application claims priority of European application No. 01 115 383.0, filed Jun. 26, 2001, the complete disclosure of which is hereby incorporated by reference.

### BACKGROUND OF THE INVENTION

a) Field of the Invention

The invention relates to a method for extending an application, which is to be installed using an installation program, by a function and to a computer software product.

b) Description of the Related Art

The increased expansion of computer networks (such as the internet) is also making the electronic distribution of software through such networks increasingly interesting, said distribution being frequently effected by software distributors who obtain the software to be distributed from software manufacturers. Due to the complexity of current programs, such software is usually available as a software package comprising an installation program and a program archive wherein the components of the desired application which are to be installed by said installation program are stored. This is done because, in many cases, the components to be installed need to be stored in different directories on the target system or even need to be registered in the operating system of the target system. Further, the installation program often enables de-installation of the application.

The components to be installed, which are stored in the installation program file and/or in additional files, are usually compressed and in many cases at least partially encrypted, the data format of said components often being proprietary and only understood by the installation program itself. Thus, if such an installation-ready application is to be subsequently expanded for distribution through a network, it is important to provide said installation-ready application with an additional function, such as a function protecting it against unauthorized use. However, since the software distributor is usually not familiar with the file format of the components to be installed and being stored in the program archive, he can not just modify or exchange the individual components to be installed.

According to one possible approach, the software distributor installs the installation-ready application and provides one of the installed components with the protective function he desires. However, since the software distributor usually does not have all the information required to generate the installation-ready software and is thus unable to generate the program archive comprising said protected component by himself, he will give the protected component to the software manufacturer, who will then in turn create an installation-ready application, now comprising the protected component, from the protected component and the remaining components. However, this procedure is very time-consuming and has the further disadvantage of incurring increased costs.

WO 99/52031 A1 discloses a method for providing an installation-ready application intended for electronic distribution with a so-called Try/Buy property, enabling customers to install the installation-ready application on their computers and try it for a predetermined period. Upon expiry of said period, further use of the application is possible only when access is enabled upon payment of its purchase price.

In order to Try/Buy-enable an installation-ready application, it is established, first of all, according to which rules the installation-ready application has been generated from the original components. On this basis, the program archive is then unpacked and a desired component is Try/Buy-enabled. Next, a new program archive is created, containing the modified, Try/Buy-enabled component instead of the selected component, said new archive being repacked according to the previously established rules, so as to ensure installation using the installation program. Thus, the desired component is removed from the original program archive and replaced by the modified component. Further, this method requires the manner in which the program archive was created to be known or determinable in order to allow generation of the modified program archive.

### OBJECT AND SUMMARY OF THE INVENTION

Thus, it is a primary object of the present invention to provide a method for extending an application, which is to be installed using an installation program, by a function, which method may be carried out without knowing the rules for generating the program archive. Moreover, a computer software product is to be provided by which the steps of the method according to the invention may be carried out.

This object is achieved by the method according to the invention for extending an application, which is to be installed using an installation program, by a function, wherein the application to be installed comprises a component to be installed using the installation program, said component being stored in a program archive, and wherein said installation program forms a software package together with said program archive, the method comprising the steps of:

adding to said software package a version of the component to be installed, extended by said function, and auxiliary code without neither partial nor complete removal of the component to be installed from the program archive, and modifying the installation program such that its execution leads to the auxiliary code being started, said auxiliary code causing the extended or modified component to be installed instead of said component.

Thus, this method does not require the program archive to be modified by removing said component (which may contain executable software code and/or data) from the program archive, thus enabling the installation-ready application to be easily extended by said function. Further, since the modified component and the auxiliary code are added to the software package outside the program archive, there is in particular no need to repack the program archive. Accordingly, the method according to the invention advantageously allows a function to be added subsequently to a software package containing an application to be installed by an installation program and does not require knowledge of the file structure of the program archive. Thus, a rapidly and easily performable method may be provided for selectively modifying a component of a program archive contained in a software package.

Advantageously, the method according to the invention also allows several additional functions to be added to the application to be installed, enabling extensive subsequent modification of the application to be installed, without requiring knowledge of the source code of the application and without having to remove the component from the program archive.

In particular, the method according to the invention also allows several applications contained in a software package to be extended by one function each. To this end, the same auxiliary code may be used for all applications to be protected, but, of course, each application to be protected has one protected component added thereto.

Further, if the application to be installed comprises several components to be installed, which are stored in the program archive, the method according to the invention also allows generating several modified components of the application to be installed and adding them to the software package, so that the function may, e.g., be improved or refined, or so that the application to be installed may comprise several additional functions. Thus, the method according to the invention allows the installation-ready application to be subsequently extended without requiring knowledge of its source code. Also, the subsequent extension by a function allows said function to always be realized in the most current manner.

The extended component may comprise the same number of files as the (original) component (e.g. one file only). However, the modified component may also have more or fewer files than the (original) component. As a rule, however, the extended component will comprise more software code than the original component so as to realize the desired function. The desired function may be a Try/Buy property or to protect the application to be installed by the installation program against unauthorized use. In this case, it is of advantage that the type of Try/Buy property or protection is freely selectable and that, in particular, the installation-ready application can always be provided with the most current Try/Buy property or the most current protection mechanism.

Further, the function may consist in data encryption, wherein the data stored by the installed application (e.g. in the target system (a computer comprising a processor, a working memory, an I/O unit and, optionally, an operating system)) is always encrypted before storage, and wherein the data read again by the installed application is decrypted again. This advantageously ensures that the data is readable only by the installed application.

Further, the desired function may also be a so-called splash message, which appears on the screen of the target system immediately upon loading the installed application and remains displayed on the screen at least until the installed application is loaded and executable; however, said splash message may, of course, be displayed longer. Such splash message allows information relating to the application, advertisement for, e.g., software products, or other data to be displayed.

The installation program may be stored in one or more files, and the component(s) to be installed may be compressed and/or at least partly encrypted and stored in the installation program file(s) and/or in additional files. The information required by the installation program for installation (e.g. for unpacking the program archive) is stored in the installation program file(s) and e.g. partly also in the program archive. The auxiliary code (which may comprise, at least, executable software code and optionally also data) may be partly or completely stored in the installation program file(s), but may also be present in one or more separate files.

The sequence of steps of the method according to the invention is freely selectable, also allowing several steps to be comprised in one single step and thus to be carried out simultaneously.

Preferably, the method according to the invention comprises adding to the software package auxiliary code, which, upon its execution, causes the extended component to be installed instead of the component upon occurrence of an event resulting from the installation program being executed. This allows selecting an event-related moment in time, at which the extended component is installed with the help of the auxiliary code, thus ensuring that, upon completion of the installation operation of the installation program and of the auxiliary code, the application extended by said function has been installed.

In a further advantageous embodiment the method according to the invention comprises adding the auxiliary code which, upon its execution, causes the already installed component to be replaced by the extended component. At the same time, the installed component is preferably deleted but may also be renamed, which is, of course, not as safe as deleting the installed component. This method requires only little interference with the installation operation of the installation program; it suffices to ensure that, upon installation of the component by the installation program, the auxiliary code is also executed (e.g. by branching from the installation program to the auxiliary code), which then causes the installed component to be replaced by the extended component.

Preferably, the replacement of the installed component by the extended component through the auxiliary code is effected when the installation of the components contained in the program archive is complete, since this is technically realizable simply by e.g. monitoring the operating system function to be called by the installation program upon completion, or by branching from the installation program to the auxiliary code before calling said function.

An advantageous embodiment of the method according to the invention also comprises adding auxiliary code which, upon its execution, prevents installation of the component and causes the extended component to be installed instead. This method has the advantage of being very safe, since the (unmodified or unprotected) component is not installed at any time and, consequently, a forced cancellation of the installation operation does not lead to the application being installed without the desired function, e.g. protection against unauthorized use.

Preferably, the method according to the invention may comprise adding auxiliary code which, upon its execution, causes the installation operation to be monitored and causes interference with said operation at the beginning of installation of the component by the installation program such that the installation of said component is prevented. Such monitoring of the installation operation may be carried out by a filter which monitors the communication between the installation program and the target system on which the application is being installed. Said filter may, for example, be setup on the operating system level of the target system. Alternatively, the installation program may also be modified such that it branches to the auxiliary code each time the operating system is called to create a file, which code may then determine whether the component is to be installed (generated) and then prevents this.

In particular, the method according to the invention allows the installation program to be modified such that during its execution the program routine installing said component is skipped. The extended (e.g. protected) component may be installed directly upon skipping said program routine or also at any other time using the auxiliary code. This also ensures that the unprotected component is never installed during installation.

Prior to the step of adding the modified component, the method according to the invention may comprise generating said component in a separate step, so that e.g. the software distributor may select and extend, all by himself, the component to be extended of the application to be installed. In this generating step, the component to be extended may be selected either automatically or manually.

In a further advantageous embodiment, if the program archive contains several components to be installed, the step of generating the extended component according to the method of the invention may comprise the steps of installing the application to be extended, selecting one of the installed components as the component to be extended, and extending the selected component.

This extension may be done e.g. by adding an additional module containing code for realizing the desired function and optionally necessary data, while, for example, the starting point in the modified component is shifted to the additional module. Also, any other technique known to the person skilled in the art may be selected as long as it ensures that, during execution of the application (and preferably the extended component), the additional module is also executed. If the application to be installed is to be protected against unauthorized use, the selected component may be supplemented with a protective module allowing execution of the modified component only in the presence of a run authorization.

This enables free selection of the component to be protected, so that the software distributor may protect the component of relevance to him. The selection of the component to be protected may be performed either automatically or manually. Thus, it is possible, for example, to select the component to be executed in order to start the installed application. This also ensures that the protective function of the installed application can not be bypassed.

Further, the above-described generation of the protected component also allows the type of protection to be freely selected. The protective module with which the component is supplemented checks, e.g., whether a certificate generated by the software distributor on the target system or a certain hardware element is present. Only if this is the case, will the required run authorization be present, allowing the protected component and, consequently, the application to be executed.

Further, the method according to the invention allows the installation program to be modified such that information contained in the installation program indicating the starting point of the installation program is modified so as to indicate as the starting point a point lying in the auxiliary code. This ensures, in a simple manner, that when calling the installation program the auxiliary code is always started immediately, so that installation of the extended application is also guaranteed.

In a further advantageous embodiment of the method according to the invention, the program archive is encrypted so as to advantageously prevent that the program archive, from which the (unmodified) component is not removed in the method according to the invention, may be installed also as an unextended application by a different installation program. Advantageously, said encryption requires neither knowledge of the file format of the program archive nor removal of the component from the program archive.

In particular, the extended component may also be encrypted, so that any undesirable modification of the extended component, e.g. one reversing the modification of said component, is effectively prevented. If several extended components are added to the software package, all of these components, or even at least only one of said components, may be encrypted.

To this end, the software package, in particular the installation program, is additionally supplemented with a decryption module (containing software code and, optionally, required data), which decrypts the encrypted program archive and optionally the encrypted component(s), e.g. only in the presence of a run authorization, such as a certificate present on the target system and created by the software distributor, a certain hardware element of the target system, an enabling code to be input or a unique identification, and thus enables the extended application to be installed.

The computer software product according to the invention comprises software code (and, if required, data), allowing the steps of the method according to the invention and, advantageously, also those of the preferred embodiments of the method according to the invention to be executed, when the product is running on a computer. In addition to the required hardware (e.g. a processor, a working memory, an output unit, an input unit), such a computer frequently also comprises an operating system. The software code (and optionally the data) of the computer software product according to the invention is adapted to said computer or said target system such that execution of the computer software product and, thus, of the software code enables the steps of the method according to the invention to be carried out.

According to an advantageous embodiment of the computer software product according to the invention, it is stored on a data storage medium. The data storage medium may be any medium from which the stored computer software product may be read out again, such as a diskette, a CD, a DVD, a magnetic tape, or a hard disk.

In the following, the invention shall be described in more detail, by way of example and with reference to the drawings.

### BRIEF DESCRIPTION OF THE DRAWINGS

In the drawings:

FIG. 1 is a scheme showing the structure of a software package including the application to be extended;

FIG. 2 is a scheme depicting the structure of the installation program contained in the software package of FIG. 1;

FIG. 3 is a flowchart showing the method according to the invention for extending the application to be installed;

FIG. 4 is a scheme showing the structure of the software package including the extended application, and

FIG. 5 is a scheme showing the structure of the installation program contained in the software package of FIG. 4.

### DESCRIPTION OF THE PREFERRED EMBODIMENTS

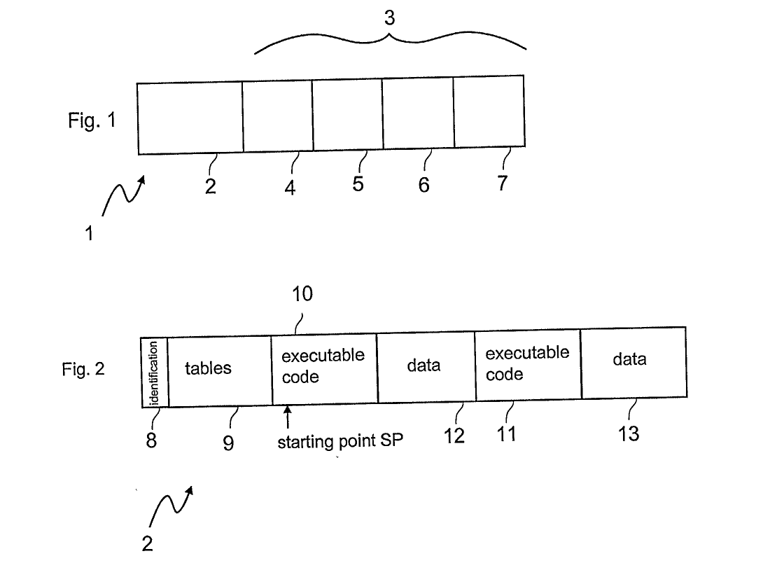

As shown in FIG. 1, the software package 1 comprises an executable installation program 2 and a program archive 3, containing the application components 4, 5, 6, 7 to be installed by the installation program 2, said components 4, 5, 6, 7 being stored in a file format accessible to the installation program 2 (e.g. in compressed form). Information relating to unpacking these compressed components 4 to 7 and to their use during installation of the application is contained in the installation program 2.

The structure and exact contents of the installation program, as shown in FIG. 2, depends at least on the operating system and on the processor of the target system (operating system and a computer featuring a processor, working memory, input unit, output unit and other hardware elements), on which the installation program is supposed to be executed.

The structure shown is described for a target system having a Pentium III processor (from INTEL Corporation) and the Windows 98 operating system from Microsoft Corporation (or also Windows 95, Windows ME, Windows 2000 or Windows NT from Microsoft) and comprises an identification 8, allowing the operating system to establish the file format (e.g. an executable file:*.exe). Further, the installation program 2 contains tables 9, describing the structure of the installation program in detail and required by the operating system in order to load the installation program into the working memory of the target system prior to its execution, so that the processor may then execute the installation program. To this end, these tables indicate, amongst others, the starting point SP, at which the processor is to start executing the program. Said starting point SP points to executable program or software code which, as shown in FIG. 2, is often present in several sections 10, 11 (the executable program code may also be present in only one or in more than two sections). Finally, sections 12 and 13 are provided wherein data is stored which is used by the installation program while it is running (such as information relating to the unpacking of the compressed components and to their use). Said data may also be stored in one or in several sections. If no data is required, said sections may also be omitted.

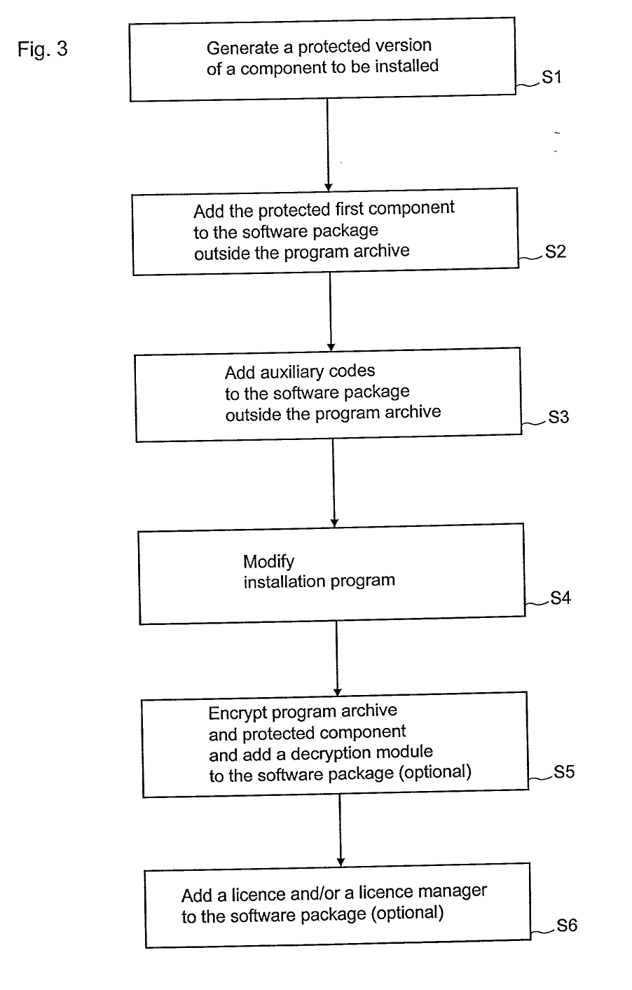

The following is a detailed description of how the application to be installed may be extended by the function conveying protection against unauthorized use. In order to protect the application to be installed, as shown in the flow chart of FIG. 3, a protected version of one of the components to be installed is generated first (step S1), if said protected version does not yet exist. This means that the installation program 2 contained in the software package 1 of FIG. 1 is executed, so as to install the application on a target system. A first component 4 to be protected is then selected from the application components installed on the target system. Said selected component 4, which is preferably a component 4 absolutely required for execution of the application, such as an executable file, is protected by providing it with a protective module 14 (in turn containing an executable code). Further, the pointer contained in component 4 and indicating the starting point is modified such that it points to the protective module 14, resulting in the code of the protective module 14 being carried out first when the modified component 4 is started. Said code of the protective module 14 determines whether a run authorization is present and, if this is the case, enables use of said component. This determination of the run authorization may, for example, be linked to the presence of a certificate, which may only be generated by the software distributor, manufacturer or by an authorized institution.

In a second step S2, the protected first component 4′ is added to the software package 1 outside the program archive 3, so that the program archive 3 is not modified in this step. In particular, this does not require knowledge of the structure or setup of the program archive.

Then, auxiliary code 15 (comprising software code and, if required, data) is also added to the software package 1 outside the program archive 3 (step S3). Said auxiliary code 15 is preferably added to the installation program 2 and, as described below, causes the protected first component 4′ to be installed instead of the first component 4 during installation of the application.

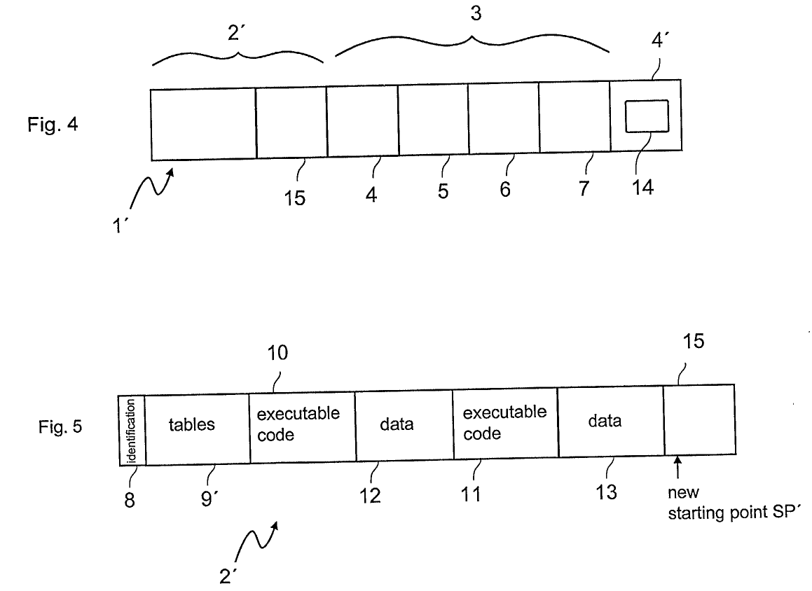

Finally, the installation program 2 is further modified (step S4) such that the auxiliary code 15 is started as a result of the execution of the modified installation program 2′. The structure of the thus modified software package 1′ is shown schematically in FIG. 4. The modification of the installation program (step S4) may be carried out, e.g., such that the starting point SP given in Tables 9 no longer points to executable code of the installation program 2, but to the auxiliary code 15 (or executable code thereof), as shown in FIG. 5 (new starting point SP′).

Steps S1 to S4 require neither the first component 4 nor the other components 5, 6, 7 to be partly or completely removed from the program archive, so that steps S1 to S4 may be executed without knowing the exact structure of the program archive. Thus, the execution of steps S1 to S4 does not necessitate a modification of the program archive 3.

Next, the program archive 3 and the protected first component 4′ may optionally be encrypted (step S5), and a decryption module (not shown) may be added to the software package. Said decryption module is preferably added to the installation program 2′ which, in this case, is modified again such that, for its execution, the encrypted program archive and the encrypted, extended first component 4′ are first encrypted, if a required run authorization is present. Next, the auxiliary code 15 is started. Advantageously, said encryption prevents that the application to be installed, which is stored in the program archive and still contains the first (unprotected) component even after carrying out the method according to the invention, may simply be installed as an unprotected application (without installation of the protected first component 4′), e.g. with a different installation program. Further, said encryption also prevents any undesirable modification of the protected first component 4′.

Optionally, a further step S6 may be carried out, wherein special licences (e.g. certificates indicating the presence of the run authorization) and/or a licence manager serving as a link between the protected application and the licence may be added, again outside the program archive 3, to the software package 1. In this case, the auxiliary code comprises a function for installing the licences and/or the licence manager on the target system.

The auxiliary code 15, which is added to the software package in step S3, is executed as a result of the modifications of the installation program in step S4 at the start of the installation program and causes the protected application (the application comprising the protected first component) to be installed on the target system upon completion of the installation operation. To this end, the auxiliary code 15 may cause the installation program 2 to delete the installed first component 4 from the target system after installation of said first (unprotected) component 4 and install the protected first component 4′ instead on the target system. Technically, this may be done by having the auxiliary code 15 monitor the operating system call of the installation program 2′, indicating the end of the installation program 2′, and, once said call appears, assume control and carry out the replacement of the installed first component 4 by the protected first component 4′. Alternatively, a branch leading to auxiliary code 15 may also be inserted in the installation program 2′ in step S4 before said operating system call occurs.

Further, the auxiliary code 15 may also be provided such that installation of the first component 4 by the installation program 2 is prevented and the protected first component 4′ is installed instead. This is technically feasible, e.g. by having the auxiliary code 15 install a filter which monitors the communication between the installation program 2′ and the target system and thus determines when installation of the first component 4 begins. At this time, control is given over to the auxiliary code 15, which installs the protected first component 4′ instead and either continues the installation program 2′ after the installation routine for the first component 4 or notifies the installation program 2′ that the installation of the first component 4 has been successfully carried out by the installation program 2′, so that the installation program 2′ will continue the installation operation as usual.

Thus, the method according to the invention for extending the application, which is to be installed, by a desired function (e.g. protection against unauthorized use) ensures that, upon completion of the installation operation, only the extended application will be installed on the target system.

The software package 1′ of FIG. 4 may be stored in one or also in several files. In connection with the modified software package 1′, some steps causing changes required for electronic distribution of the modified software package may also be carried out, if necessary.

While the foregoing description and drawings represent the present invention, it will be obvious to those skilled in the art that various changes may be made therein without departing from the true spirit and scope of the present invention.

What is claimed is:

1. A method for extending an application, which is to be installed using an installation program, by a function, wherein the application to be installed comprises a component to be installed by the installation program, said component being stored in a program archive, and wherein said installation program forms a software package together with said program archive, the method comprising the steps of:
adding to said software package a version of the component to be installed, said version being extended by said function, and auxiliary code without removing the component to be installed from the program archive, and modifying the installation program such that its execution leads to the execution of the auxiliary code, said auxiliary code causing the extended component to be installed instead of said component.

2. The method according to claim 1, wherein the auxiliary code, when being executed, causes the extended component to be installed upon occurrence of an event resulting from the execution of the installation program.

3. The method according to claim 1, wherein the auxiliary code, when being executed, causes the already installed component to be replaced by the extended component, this being carried out upon completion of the installation of all components contained in the program archive.

4. The method according to claim 1, wherein the auxiliary code, when being executed, prevents the installation of the component and, instead, causes the extended component to be installed.

5. The method according to claim 4, wherein the installation program is modified by the auxiliary code such that, during execution of the installation program, the program routine for installation of component is skipped, or wherein the auxiliary code, while being executed, monitors the installation operation and interferes with the installation operation once installation of component begins so as to prevent the component from being installed.

6. The method according to claim 1, comprising the step of generating the extended component before the adding step.

7. The method according to claim 6, wherein the program archive comprises a plurality of components to be installed and the step of generating the extended component comprises the steps of: installing the application to be extended, selecting one of the installed components as the component to be extended and extending said selected component.

8. The method according to claim 1, wherein the installation program is modified such that information on the starting point of the installation program contained in said installation program is modified such that the starting point now lies in auxiliary code.

9. The method according to claim 1, wherein the application to be installed is extended by a function for protection against unauthorized use, and a protection module is added to the selected or extended component, which module allows the extended component to be executed only in the presence of a run authorization.

10. The method according to claim 1, wherein the program archive and the extended component are encrypted and a decrypting module for decrypting the program archive and optionally the extended component before installation of the application to be installed is added to the software package.

11. The method for extending an application, which is to be installed using an installation program, by a function, wherein the application to be installed comprises a plurality of components to be installed by the installation program, said components being stored in a program archive, and wherein said installation program forms a software package together with said program archive, the method comprising the steps of:
installing the application to be extended by the installation program;
selecting one of the installed components;
copying the selected component and extending the component being copied by said function for generating an extended component;
adding to said software package the extended component and auxiliary code without removing the selected component from the program archive; and
modifying the installation program such that its execution leads to the execution of the auxiliary code, said auxiliary code causing the extended component to be installed instead of said selected component.

12. A computer software product comprising software code for carrying out the steps according to claim 1, when the product is running on a computer, said computer software product preferably being stored on a data storage medium.

13. A computer software product comprising software code for carrying out the steps according to claim 11, when the product is running on a computer, said computer software product being stored on a data storage medium.
